(19) United States
(12) Patent Application Publication
(10) Pub. No.: US 2009/0237826 A1
(43) Pub. Date: Sep. 24, 2009

(54) DATA STORAGE APPARATUS

(75) Inventor: Masayuki Kondo, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/398,691

(22) Filed: Mar. 5, 2009

(30) Foreign Application Priority Data
Mar. 19, 2008 (JP) 2008-072195

(51) Int. Cl. G11B 5/09

(52) U.S. Cl. 360/51; G9B/5.033

(57) ABSTRACT

A data storage apparatus includes: a medium for storing data including sectors, each of the sectors including a synchronization mark indicating the data start position in each of the sectors; a memory for storing types of synchronization marks stored in the sectors; and a processor for executing a process including receiving a write request, reading out a synchronization mark type from the memory, overwriting data, a new synchronization mark into the sector, and the new synchronization mark into the memory, receiving a read request, reading out the synchronization mark and the data from one of the sectors, reading out the type of the synchronization mark from the memory, and determining whether correct data is read out from the sector by matching the type of the synchronization mark between read out from the sector and read out from the memory.

### CROSS-REFERENCE TO RELATED APPLICATION

This application is based upon and claims the benefit of priority of the prior Japanese Patent Application No. 2008-072195, filed on Mar. 19, 2008, the entire contents of which are incorporated herein by reference.

### FIELD

The embodiment relates to a data storage apparatus

### BACKGROUND

A magnetic disk apparatus is an apparatus that records and reproduces data specified by a host. At the time of writing data, data specified by the host are encoded by a hard disk controller (HDC) and a read channel (RDC) and then the encoded data are written through a preamplifier from a write head onto a recording surface of a disk (recording medium). At the time of reading data, a read head reads a recorded signal on the disk, the read signal is amplified by the preamplifier, the data are decoded by the RDC and the HDC, and then the decoded data are transmitted to the host.

Here, in regard to a data writing process, taking into consideration the accuracy of a track position of the magnetic disk apparatus by itself (ontrack accuracy), the influence of external vibration, or the like, offset writing (writing on a position that deviates from the center position of a track) is allowed within a predetermined range.

When the offset amount is set to be excessively large, data in an adjacent sector are offset-erased. On the other hand, when the offset amount is set to be excessively small, a writing error appears frequently to thereby deteriorate the performance for writing. For this reason, an offset suitable for the apparatus is set as an allowable offset for writing.

FIG. 11A and FIG. 11B are views that illustrate the known problem of offset writing. A sector N will be described. Data in the sector N are offset-written as indicated by “Sector N Offset” in FIG. 11A. In this case, it is assumed that data are overwritten at portions indicated by color-coded areas in FIG. 11B. In the sector N, old data before overwriting and new data after overwriting are written in opposite phases within the range of the allowable offset, and the unerased old data are left.

As described above, when the old data are left in a readable state, the new data and the old data coexist in one sector. However, in the existing art, even when the old data are read at the time of reading data in the sector N illustrated in FIG. 11B, it has not been able to determine that data are read incorrectly.

### SUMMARY

According to an aspect of the invention, an apparatus for storing data includes: a medium for storing data including a plurality of sectors, each of the plurality of sectors including a synchronization mark indicating the position of the start of data in each of the sectors; a memory for storing types of synchronization marks stored in the sectors; and a processor for executing a process including: receiving a write request for writing data into one of the sectors, reading out a type of the synchronization mark corresponding to the one of the sectors identified by the write request from the memory, overwriting data and a new synchronization mark different from the synchronization mark read out from the memory into the sector, overwriting the new synchronization mark to correspond to the one of the sector into the memory, receiving a read request for reading out the data from one of the sectors, reading out the synchronization mark and the data from one of the sectors identified by the read request, reading out the type of the synchronization mark corresponding to the one of the sectors identified by the read request from the memory, and determining whether correct data is read out from the sector by matching the type of the synchronization mark between read out from the sector and read out from the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A, FIG. 1B, and FIG. 1C are views that illustrate a method of determining whether data are new or old according to the aspects of the invention.

FIG. 2 is a view that illustrates the data format of a sector and sync byte detection of a read channel.

FIG. 3 is a view that illustrates a sync byte pattern.

FIG. 4 is a view that illustrates a sync byte pattern table.

FIG. 5 is a view that illustrates an arrangement example when the sync byte pattern tables are provided in a recording medium.

FIG. 6A, FIG. 6B, FIG. 6C, FIG. 6D, and FIG. 6E are views that illustrate a process of writing data when the sync byte pattern tables are provided in the recording medium.

FIG. 6F, FIG. 6G, FIG. 6H, and FIG. 6I are views that illustrate a process of reading data when the sync byte pattern tables are provided in the recording medium.

FIG. 7 is a view that illustrates an arrangement example when the sync byte pattern tables are provided in a nonvolatile memory.

FIG. 8A, FIG. 8B, FIG. 8C, and FIG. 8D are views that illustrate a process of writing data when the sync byte pattern tables are provided in the nonvolatile memory.

FIG. 8E, FIG. 8F, and FIG. 8G are views that illustrate a process of reading data when the sync byte pattern tables are provided in the nonvolatile memory.

FIG. 9A is a view that illustrates a method of writing data in successive sectors using a sync byte.

FIG. 9B is a view that illustrates a method of reading data in successive sectors using a sync byte.

FIG. 10A, FIG. 10B, FIG. 10C, FIG. 10D, FIG. 10E, and FIG. 10F are views that illustrate a retry process when a data writing operation ends before updating the sync byte pattern table.

FIG. 11A and FIG. 11B are views that illustrate the known problems of offset writing.

### DESCRIPTION OF EMBODIMENT

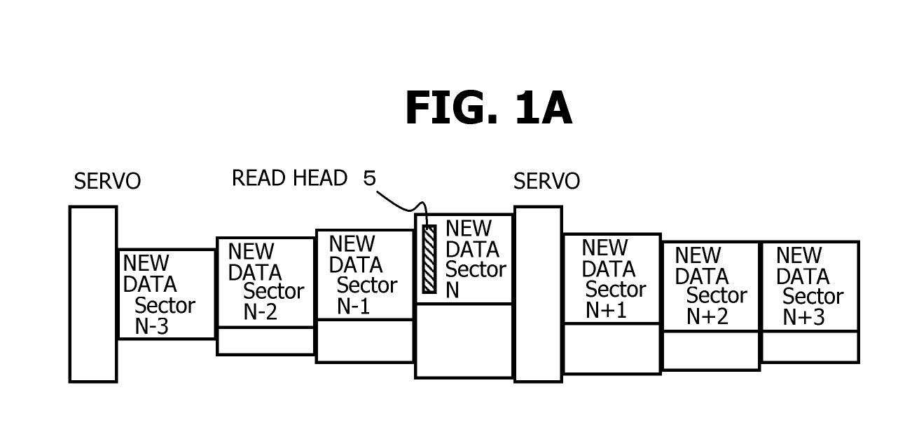

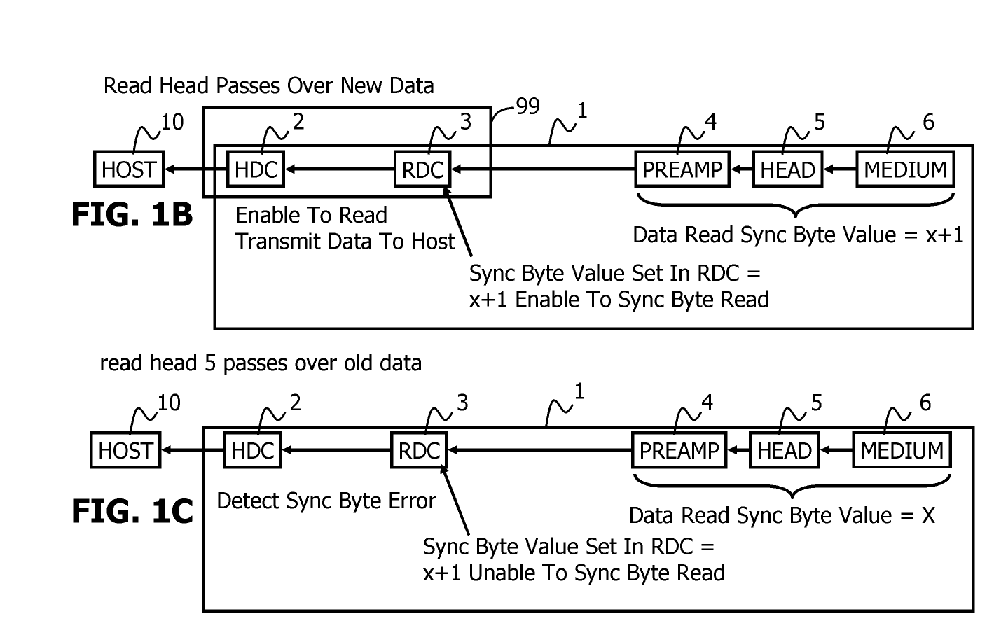

Hereinafter, a preferred embodiment of the invention will be described in detail with reference to the accompanying drawings. FIG. 1A, FIG. 1B, and FIG. 1C are views that conceptually illustrate a method of determining whether data are new or old by a magnetic disk apparatus according to the aspects of the invention. FIG. 1A illustrates a state of a recording medium (disk). FIG. 1B and FIG. 1C are configuration diagrams of a magnetic disk apparatus according to the aspects of the invention.

In FIG. 1A, areas in which data are newly recorded are color-coded. For example, new data are recorded in color-coded portions in a sector N and old data are left in the remaining portions.

At the time of reading data, a read head of the magnetic disk apparatus passes over the recording medium to read out information stored in each sector. Positioning of the read head is performed by a servo. In the aspects of the invention, by referring to sector information set in each sector, it is determined whether the data are new or old. Hereinafter, an embodiment in which a sync byte (SB) (synchronization mark) is used as sector information will be described.

The magnetic disk apparatus 1 illustrated in FIG. 1B and FIG. 1C is connected to a host 10, and includes a hard disk controller (hereinafter, HDC) 2, a read channel (hereinafter, RDC) 3, a preamplifier 4, a head 5 and a recording medium (in the drawing, indicated as “MEDIUM”) 6. Note that only the configuration of the magnetic disk apparatus 1 in connection with the aspects of the invention is illustrated. For example, a processor 99 may integrate the HDC 2 and the RDC 3.

The recording medium 6 is formed of a magnetic disk for recording data. The head 5 is formed of a read head and a write head. The read head passes over sectors to read out information recorded in the recording medium 6. The write head writes information to the recording medium 6. Hereinafter, when data reading and data writing are respectively described, the read head and the write head are assigned with the same reference numeral. The preamplifier 4 amplifies a signal read from the recording medium 6 and transfers the amplified signal to the RDC 3.

The HDC 2 controls reading and writing of data by the magnetic disk apparatus 1. In regard to data writing, the HDC 2 sets the read channel of a sector from which data are to be read. The RDC 3 uses a value of a sync byte set by the HDC 2 to read out data from the recording medium 6.

FIG. 1B illustrates the flow of process when the read head 5 passes over new data indicated by color-coding in FIG. 1A. FIG. 1C illustrates the flow of process when the read head 5 passes over old data.

When the read head 5 passes over new data, a sync byte value x stored in the sector of the recording medium 6 coincides with a sync byte value x set in the RDC 3. In this case, it is determined that data stored in the sector are new data, and the HDC 2 transmits the data to the host 10.

In contrast, when the read head 5 passes over old data, a sync byte value x stored in the sector of the recording medium 6 does not coincide with a sync byte value x+1 set in the RDC 3, and reading of the sync byte cannot be performed. In this case, a sync byte error is detected, and then it is determined that data stored in the sector are old data.

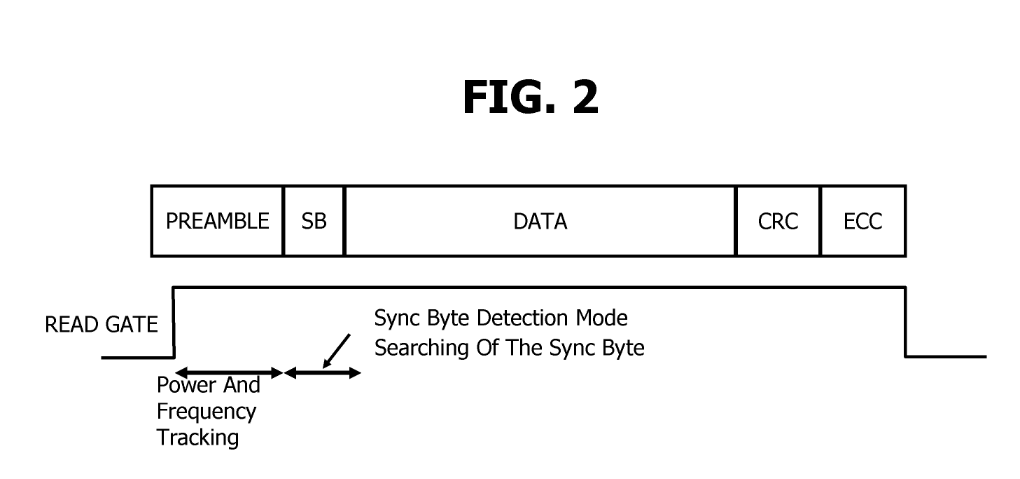

Hereinafter, a method of determining whether data are new or old using a sync byte will be specifically described. FIG. 2 is a view that illustrates the data format of a sector and sync byte detection of the read channel.

One sector includes a preamble, a sync byte (SB), data, a CRC (cyclic redundancy check) and an ECC (error correcting code).

The preamble is mainly used for power tracking and frequency tracking. The sync byte is normally used for indicating the start position of data. In the present embodiment, the sync byte is also used for determining whether data in the sector are new or old.

The data are actual data to be recorded in the recording medium 6 in accordance with an command from the host. The CRC and ECC both are information for detecting a data error. As a read gate is switched on in accordance with a command from the HDC 2 to start driving the read head 5, the RDC 3 initially reads out the preamble portion to perform adjustment of frequency and power for data, and the like. After these adjustments, searching of the sync byte is started. Within the data waveform, a data pattern corresponding to the sync byte is searched, and then initiation of data (actual data) is determined at the time when the pattern corresponding to the sync byte is detected.

A plurality of data patterns (types) of the sync byte are held in the RDC 3 in advance, and the actually set sync byte pattern is changed by changing a value of the register, which is set in the RDC 3.

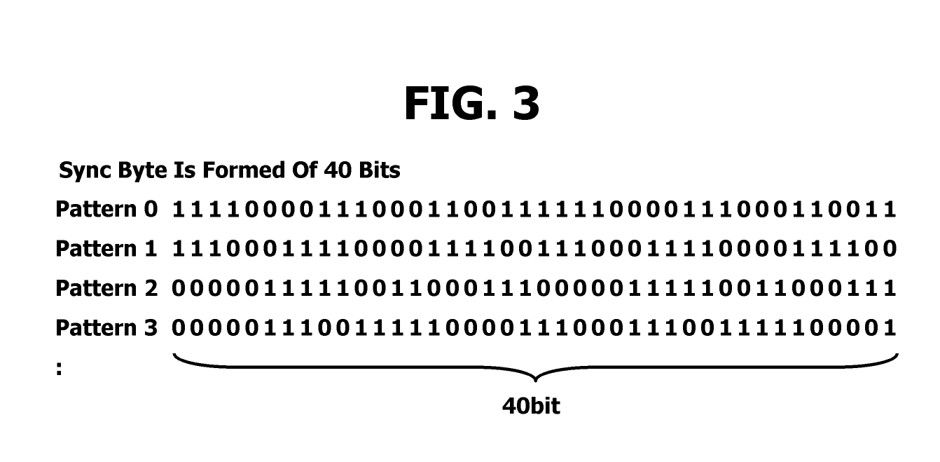

FIG. 3 is a view that illustrates a sync byte pattern. The example illustrated in FIG. 3 illustrates the case in which the sync byte is formed of 40 bits. In the existing art, the data pattern of a normal sync byte is one pattern; in the present embodiment, as illustrated in FIG. 3, a plurality of data patterns are prepared and the data pattern is changed every time data are written.

Among the plurality of data patterns set in advance as illustrated in FIG. 3, values that are actually set in the sync bytes are held in the pattern table. At the time of writing or reading data, the pattern table is referred to and then setting of the RDC 3 is performed.

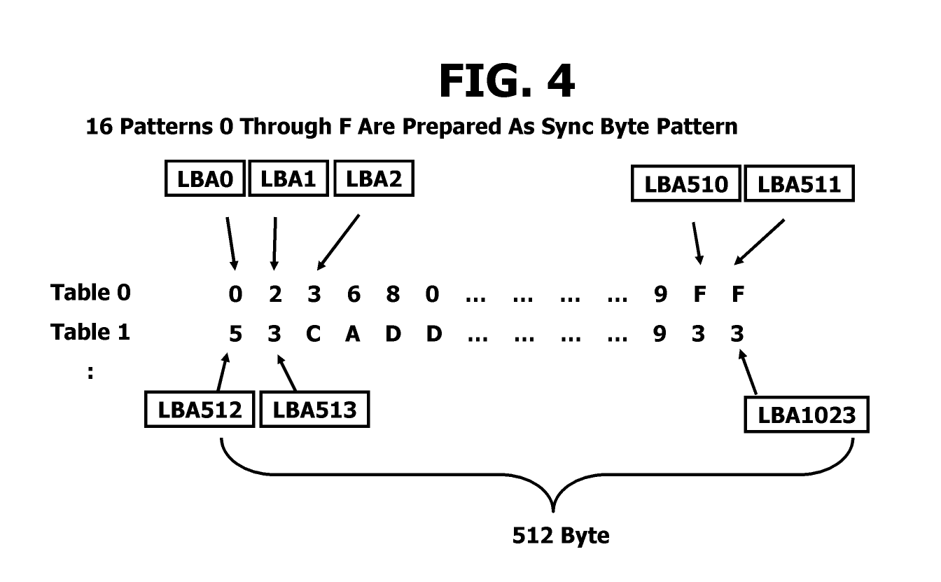

FIG. 4 is a view that illustrates a sync byte pattern table. Here, an example in which 16 patterns are prepared as the data pattern of the sync byte and the pattern table is provided in an area other than a user area of the recording medium 6 will be described.

If one sector is formed of 512 bytes, and one byte is allocated as an area for storing a sync byte set in a sector, one sync byte pattern table (one sector) holds sync bytes for 512 sectors. For example, when the sync byte of a sector of LBA (Logical Block Addressing) ranging from 0 to 511 is held in a table 0, when the sync byte of a sector of LBA ranging from 512 to 1023 is held in a table 1. In this way, the sync byte set in each sector is held at a predetermined position in a table determined on the basis of the LBA of the sector.

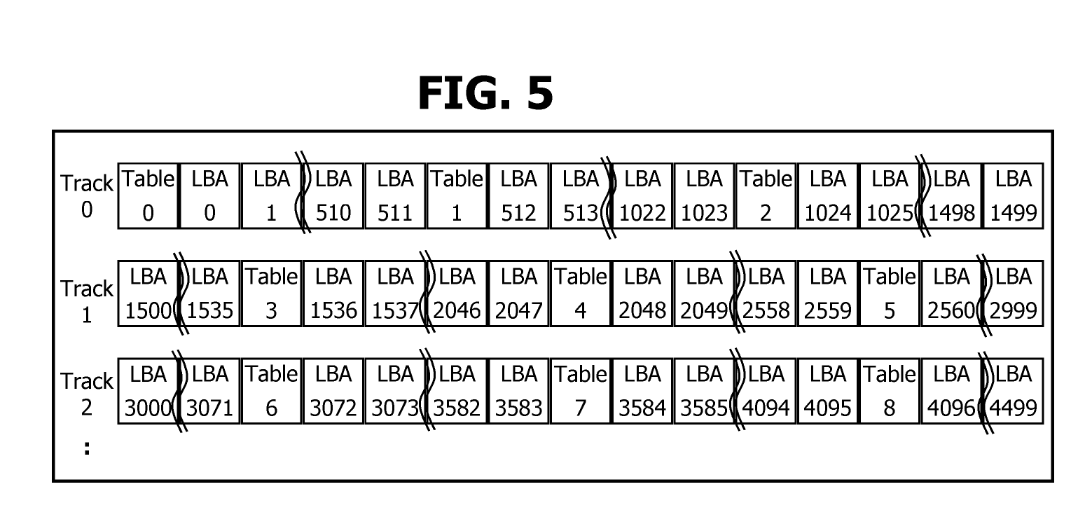

FIG. 5 is a view that illustrates an arrangement example when the sync byte pattern tables are provided in the recording medium 6. The recording medium 6 illustrated in FIG. 5 is formed of 1500 sectors in one track. As illustrated in FIG. 5, in the embodiment, when the sync byte pattern tables are provided in the recording medium 6, tables are arranged so that a sync byte of each sector held in the table is located near the corresponding sector. In the configuration example of the above sync byte pattern table, the table 0 of the track 0 stores the sync bytes for sectors of LBAs ranging from 0 to 511. Then, the table 0 is arranged before the sectors of LBAs ranging from 0 to 511, and before the subsequent sectors of LBAs ranging from 512 to 1023, the corresponding table 1 is arranged. By so doing, deterioration of the performance due to accessing to the sync byte data pattern is suppressed to a lesser degree.

Note that, for example, for the sectors of LBAs ranging from 1024 to 1535, the sync bytes are stored in the table 2 of the track 0; however, of these, the sectors of LBAs ranging from 1500 to 1535 are arranged in a track (track 1) that is different from the track 0 in which the table 2 is arranged because of the structure of the tracks.

Note that in the example illustrated in FIG. 5, tables are provided on the recording surface of the recording medium 6, and reading and writing of sync bytes from the tables may possibly be incorrect due to offset writing as in the case of the sectors that store data. However, the sync byte values of the sync byte pattern table itself are set to predetermined values and will not be changed.

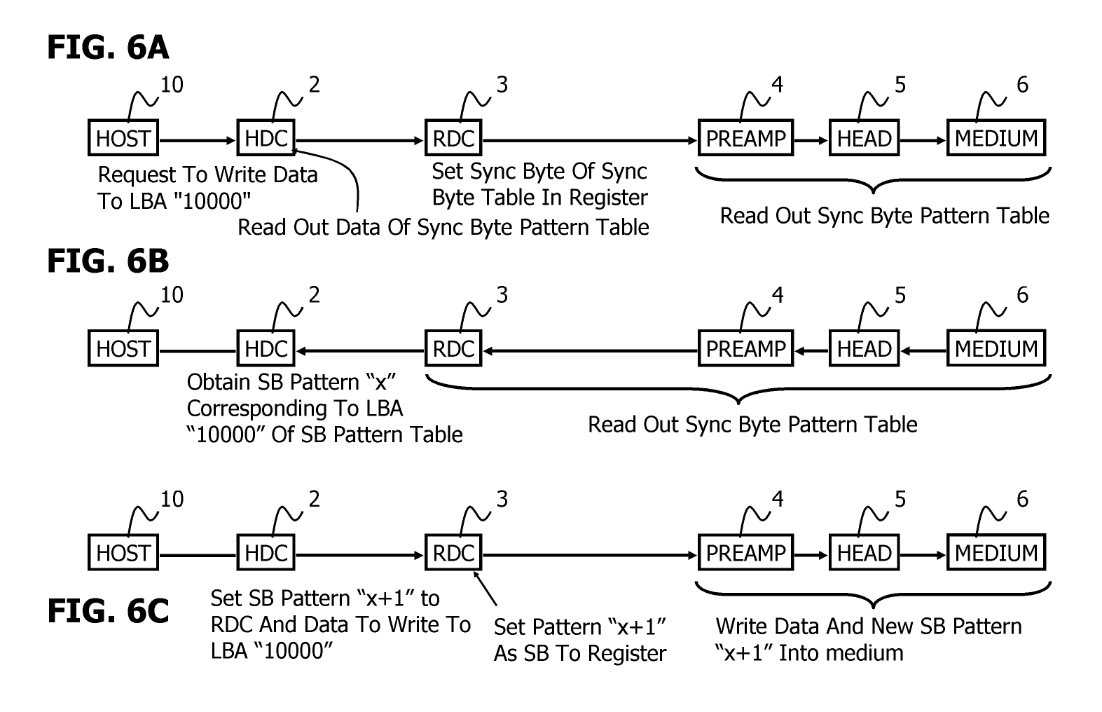

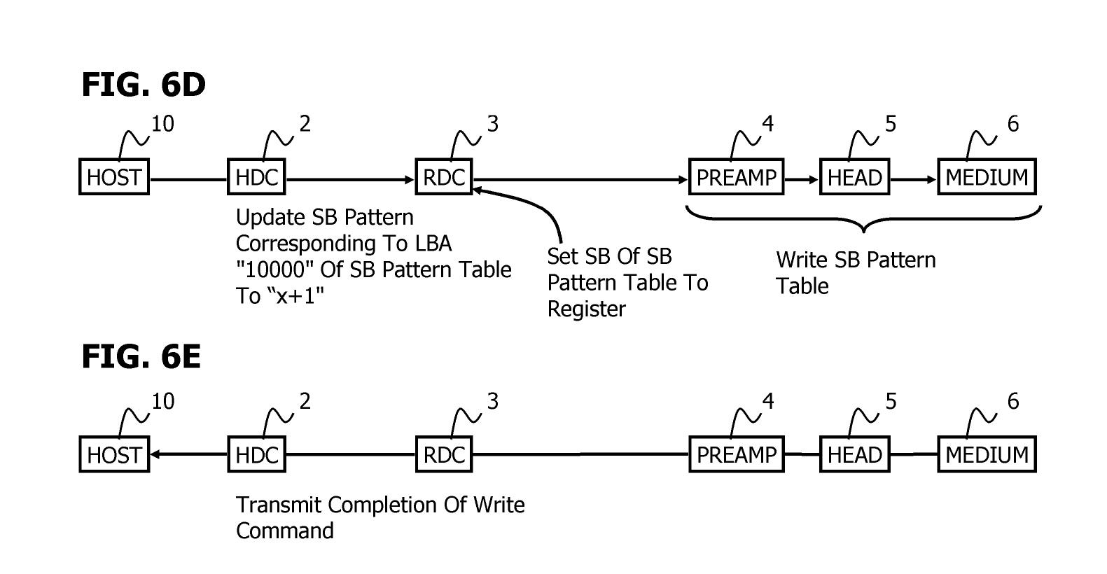

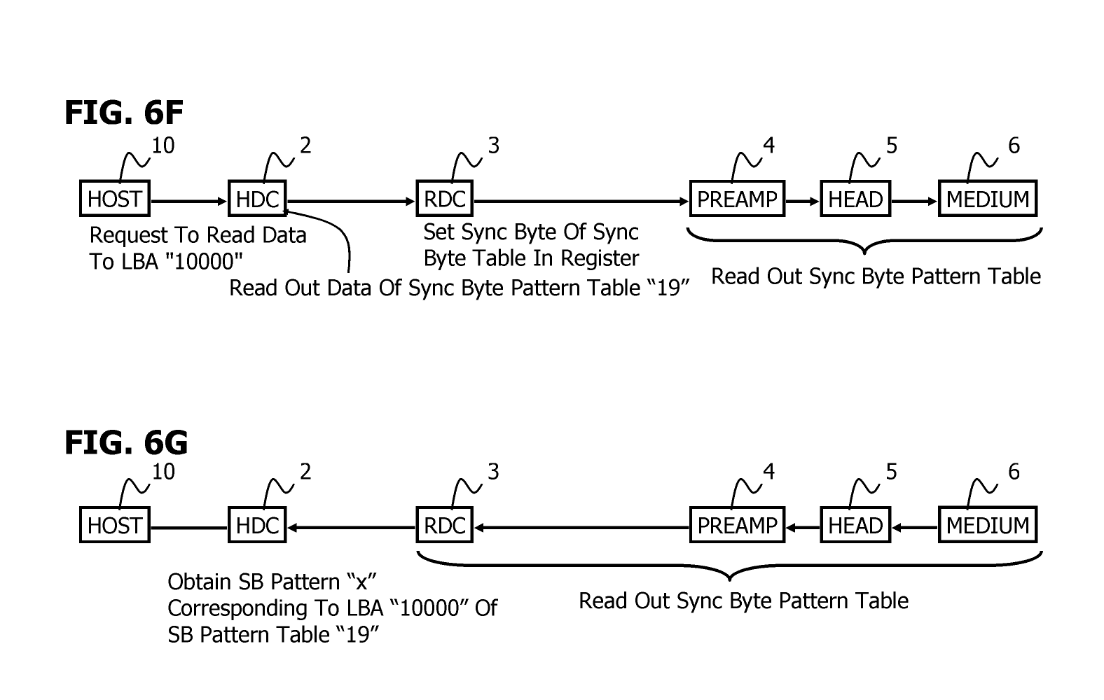

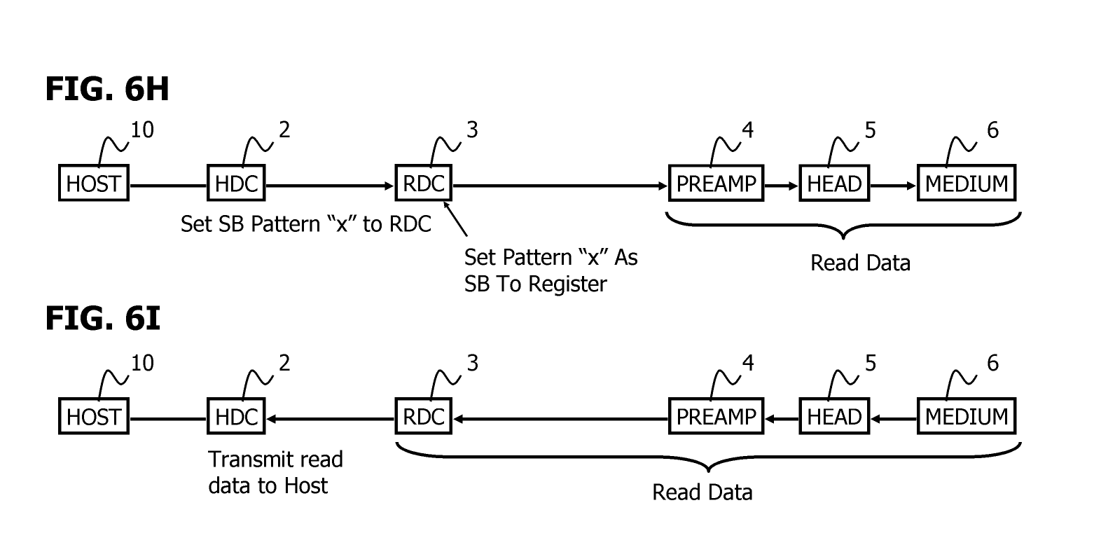

The process of actual data writing or data reading when a sync byte pattern table is provided in the recording medium 6 will be specifically described. FIG. 6A, FIG. 6B, FIG. 6C, FIG. 6D, FIG. 6E, FIG. 6F, FIG. 6G, FIG. 6H, and FIG. 6I are views that illustrate the process of writing data and the process of reading data when the sync byte pattern tables are provided in the recording medium. An example in which overwriting and reading of data are performed on the sector of LBA “10000” will be described. In addition, here, the sync byte pattern table is formed as illustrated in FIG. 5, and one table holds sync bytes for 512 sectors.

FIG. 6A, FIG. 6B, FIG. 6C, FIG. 6D, and FIG. 6E are views that illustrate the process of writing data. First, in the step of FIG. 6A, as the HDC 2 receives the command to write data to the sector of LBA “10000” from the host 10, the HDC 2 requests the RDC 3 to read out data of the sync byte pattern table “19” that holds the sync byte pattern for the sector of LBA “10000”. The RDC 3, in accordance with the command from the HDC 2, sets the sync byte for the sector of the sync byte pattern table “19” in the register, and reads out the sync byte for the sector of LBA “10000” from the table of the table number “19”.

Next, in the step of FIG. 6B, the HDC 2 acquires a value “x” of the sync byte corresponding to LBA “10000” from the sync byte pattern table “19”. Next, in the step of FIG. 6C, the HDC 2 requests the RDC 3 to set a value (here, x+1) different from the value “x” of the acquired sync byte for the sync byte of LBA “10000”. The RDC 3 sets the value “x+1” in the register as the sync byte, writes data in the sector of LBA “10000”, and writes “x+1” as the sync byte.

Next, in the step of FIG. 6D, the HDC 2 updates the sync byte pattern table “19” and writes the sync byte “x+1”, which is newly set for the sector of LBA “10000”, in the corresponding portion of the sync byte pattern table. Next, in the step of FIG. 6E, as the HDC 2 receives a report that writing is complete, the process ends.

FIG. 6F, FIG. 6G, FIG. 6H, and FIG. 6I are views that illustrate the process of reading data. First, in the step of FIG. 6F, as the HDC 2 receives, from the host 10, the command to read data from the sector of LBA “10000”, the HDC 2 requests the RDC 3 to read out data of the sync byte pattern table “19” that holds the sync byte for the sector of LBA “10000”. The RDC 3, in accordance with the command from the HDC 2, sets the sync bytes for the sectors in the sync byte pattern table “19” in the register, and reads out the sync byte for the sector of LBA “10000” from the table of the table number “19”.

Next, in the step of FIG. 6G, the HDC 2 acquires a value “x” of the sync byte corresponding to LBA “10000” from the sync byte pattern table “19”. Next, in the step of FIG. 6H, the HDC 2 requests the RDC 2 to set the acquired sync byte value “x” as the sync byte for the sector of LBA “10000”. The RDC 3 sets the value “x” in the register as the sync byte, and reads data from the sector of LBA “10000”. Finally, in the step of FIG. 6I, the HDC 2 transmits the read data to the host 10, and the process ends.

As described with reference to FIG. 6A, FIG. 6B, FIG. 6C, FIG. 6D, and FIG. 6E, when the data are written to the recording medium 6, first, the sync byte values stored in the sync byte pattern table are read, and the read sync bytes are set in the register of the RDC 3 to thereby read out the sync byte for the sector. Then, a sync byte having a value different from the value used for reading the sync byte is newly set to write data, and the newly set sync byte is also registered in the corresponding sync byte pattern table.

Then, as described with reference to FIG. 6F, FIG. 6G, FIG. 6H, and FIG. 6I, when data are read from the recording medium 6, the sync byte values stored in the sync byte pattern table are read, and the read sync bytes are set in the register of the RDC 3 to thereby read out data. Because a different sync byte is set in each writing process, even when unerased old data are present in the sector, the sync byte value of the old data is different from the value set in the register of the RDC 3. Therefore, at the time of reading data, even when the read head 5 is driven to the area of the old data to try to read the old data, a sync byte error occurs and, as a result, there is no chance to erroneously read the old data.

The case in which the sync byte pattern tables are provided on the recording medium side is described above; however, the location of the sync byte pattern tables is not limited to it. For example, the sync byte pattern tables may be provided in a means other than the recording medium 6, for example, a nonvolatile memory.

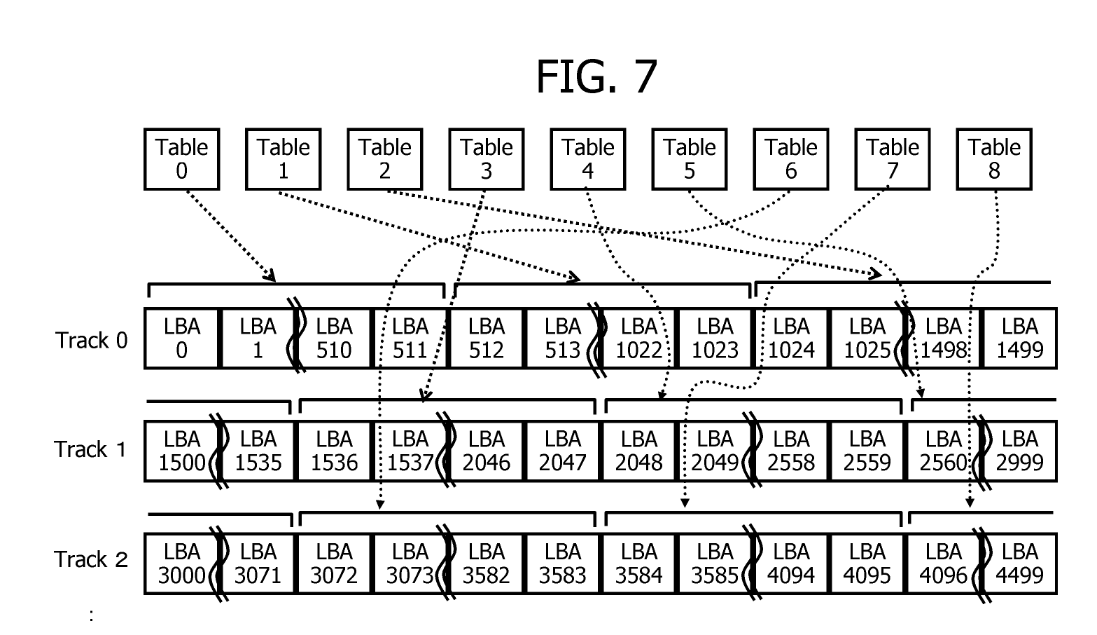

Next, the case in which the sync byte pattern tables are provided outside the recording medium 6, such as a nonvolatile memory, will be described. FIG. 7 is a view that illustrates an arrangement example when the sync byte pattern tables are provided in the nonvolatile memory. An example in which one sector of the nonvolatile memory has 512 bytes will be described.

The respective sync bytes of the 512 sectors of the recording medium 6 are recorded in one sector of the nonvolatile memory. As in the case in which the tables are provided in the recording medium 6, which table stores a sync byte is calculated for the LBA of the target sector on which writing or reading of data will be performed to thereby acquire the desired sync byte. When the sync byte pattern tables are provided in the nonvolatile memory, it is less likely to read a table incorrectly and, therefore, the sync bytes values may be held safely.

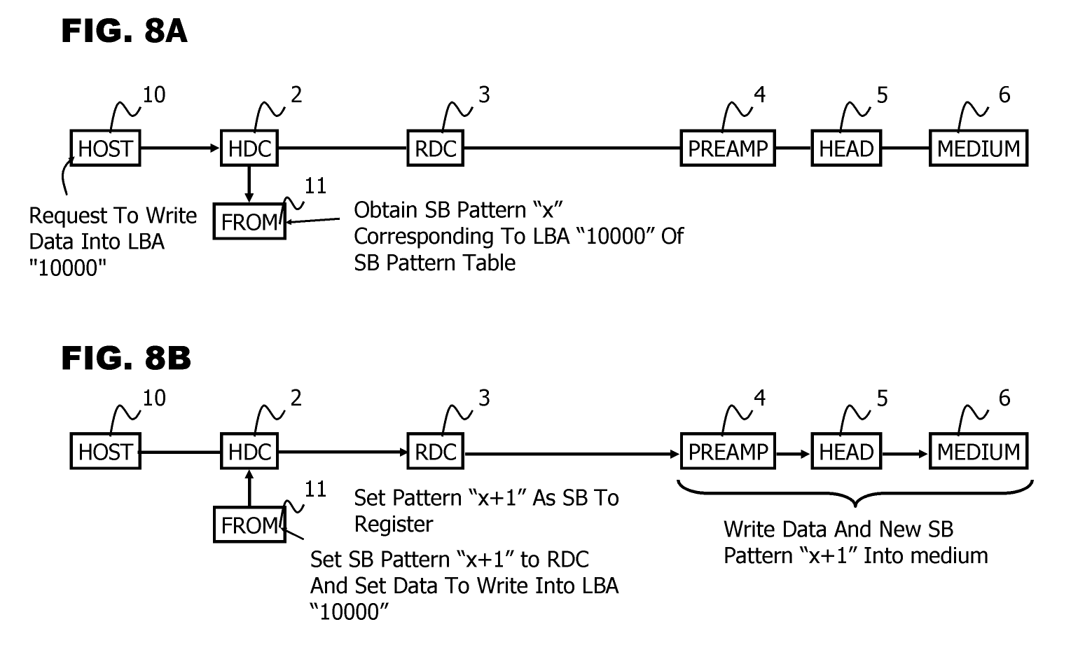

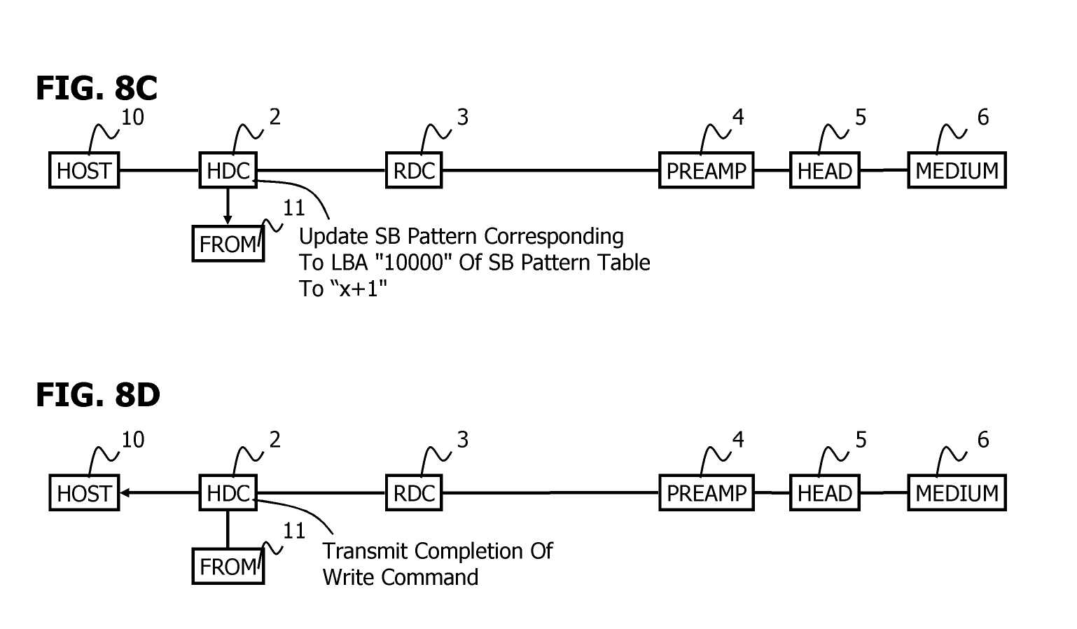

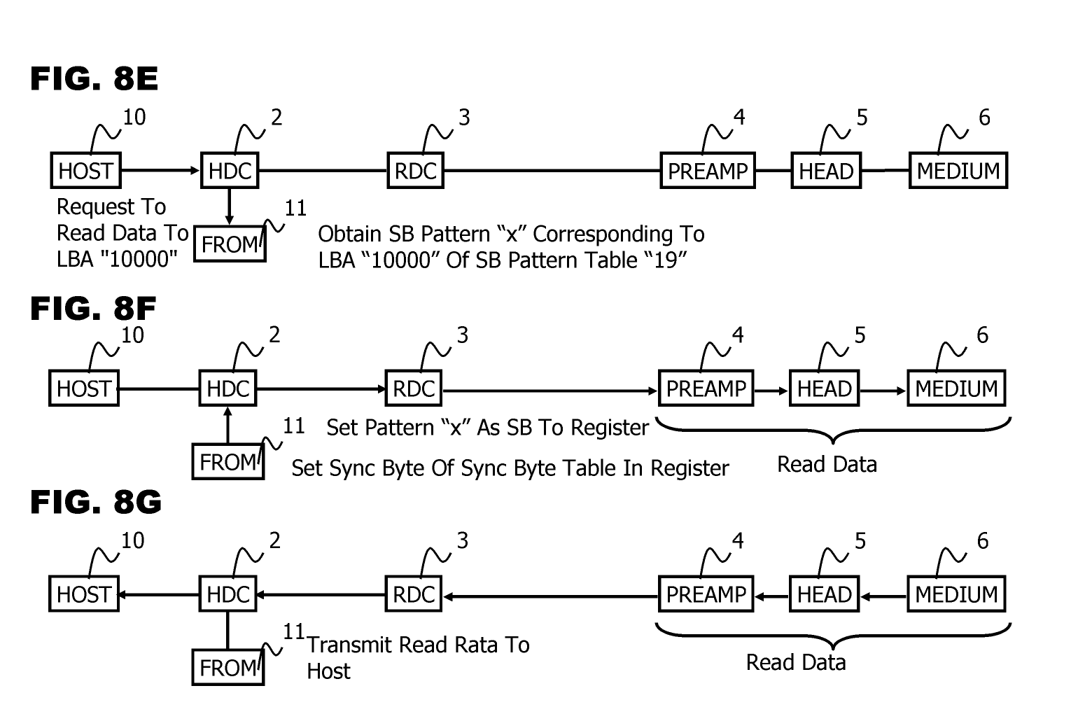

FIG. 8A, FIG. 8B, FIG. 8C, FIG. 8D, FIG. 8E, FIG. 8E, and FIG. 8G are views that illustrate the process of writing data and the process of reading data when the sync byte pattern tables are provided in the nonvolatile memory. As in the case of FIG. 6A, FIG. 6B, FIG. 6C, FIG. 6D, FIG. 6E, FIG. 6F, FIG. 6G, FIG. 6H, and FIG. 6I, an example in which overwriting and reading of data are performed on the sector of LBA “10000” will be described. The nonvolatile memory (FROM) 11 illustrated in FIG. 7 is configured so that one table holds sync bytes for 512 sectors.

Hereinafter, a difference in process from the configuration in which the sync byte pattern tables are provided on the recording medium 6 illustrated in FIG. 6A, FIG. 6B, FIG. 6C, FIG. 6D, FIG. 6E, FIG. 6F, FIG. 6G, FIG. 6H, and FIG. 6I will be mainly described. FIG. 8A, FIG. 8B, FIG. 8C, and FIG. 8D are views that illustrate the process of writing data. In the step of FIG. 8A, corresponds to the step of FIG. 6A and the step of FIG. 6B, and in accordance with the command from the host 10, the HDC 2 acquires a sync byte from the nonvolatile memory 11. The steps of FIG. 8B, FIG. 8C, and FIG. 8D respectively correspond to the steps of FIG. 6C, FIG. 6D, and FIG. 6E, and description thereof is omitted.

FIG. 8E, FIG. 8F, and FIG. 8G are views that illustrate the process of reading data. The step of FIG. 8E corresponds to the steps of FIG. 6F and FIG. 6G, and in accordance with the command from the host 10, the HDC 2 acquires a sync byte from the nonvolatile memory 11. The steps of FIG. 8F and FIG. 8G respectively correspond to the steps FIG. 6H and FIG. 6I, and description thereof is omitted.

In this manner, even when the sync byte pattern tables are provided outside the recording medium 6, here, in the nonvolatile memory 11, it is possible to read data by determining whether data are new or old using the sync byte in the similar manner.

The above method of determining whether data recorded in the sector are new or old using the sync byte is not limited to writing or reading of data to one sector. For example, the method may also be applied to the case in which writing or reading of data is performed on successive sectors.

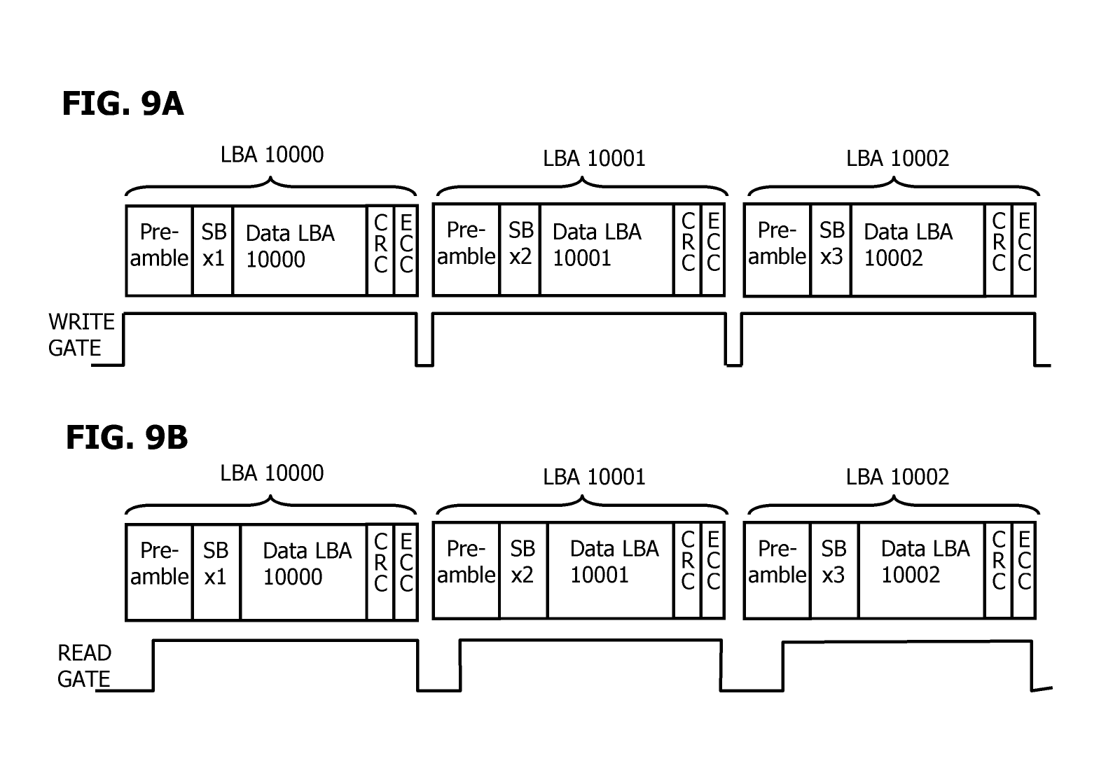

FIG. 9A is a view that illustrates a method of writing data in successive sectors using sync bytes. FIG. 9A is a view that illustrates a method of writing data to successive sectors. FIG. 9B is a view that illustrates a method of reading data from successive sectors.

First, the method of writing data to successive sectors will be described. As illustrated in FIG. 9A, data are written to the sectors of three successive LBAs 10000 to 10002.

From the LBAs of the sectors to which data will be written, the table number “19” of the sync byte pattern table, in which the sync bytes values are stored, is calculated and the sync bytes are acquired from that table. In the example illustrated in the drawing, “x1, “x2” and “x3” are respectively acquired for the sectors of LBAs 10000, 10001 and 10002.

Then, values different from the acquired sync bytes, that is, the sync bytes set in the sectors, are reset for the respective sectors. In the example illustrated in the drawing, data are written to the sectors of LBAs 10000, 10001 and 10002, and “x1+1”, “x2+1” and “x3+1” are respectively set for those sectors. The set values are registered at predetermined portions of the sync byte pattern table to update the values, as in the case for one sector.

When new sync byte values (x1+1, x2+1, x3+1) are written for the sectors, in the RDC 3, the values in the register are changed in accordance with on/off of the signal of the write gate. In the example illustrated in the drawing, at the timing at which the write gate switches from off state to on state, the values are set respectively to x1+1, x2+1 and x3+1, thus enabling writing to the above successive sectors.

Next, the method of reading data from successive sectors will be described. As illustrated in FIG. 9B, data are read out from the three successive sectors of LBAs 10000 to 10002.

From the LBAs of the sectors from which data will be read, the table number “19” of the sync byte pattern table, in which the sync bytes values are stored, is calculated and the sync bytes are acquired from that table. In the example illustrated in the drawing, “x1, “x2” and “x3” are respectively acquired for the sectors of LBAs 10000, 10001 and 10002.

Then, the acquired sync bytes are set to the RDC 3 and then data are sequentially read out from these successive sectors. Only when the set sync byte coincides with the sync byte acquired from the sync byte pattern table, the data are determined to be new data and are read out.

When data are read out from the sectors, in the RDC 3, the values in the register are sequentially changed in accordance with on/off of the signal of the read gate. In the example illustrated in the drawing, at the timing at which the read gate switches from off state to on state, the values are set respectively to x1, x2 and x3, thus enabling reading from the above successive sectors.

As described above, in the present embodiment, sync bytes different from those of the old data are set for new data at the timing at which data are written, and the set sync bytes are held in the table. At the time of reading data, reading is performed using the sync bytes acquired from the table, and data are read out from the sectors to which the sync bytes that coincide with the values held in the table are set. By so doing, it is possible to determine whether data are new or old.

That is, in order to properly determine whether data in a sector are new or old, it is important that the sync byte value of the sector coincides with the sync byte value held in the sync byte pattern table. In the above embodiment, in the process of writing data to a sector, first, the updated sync byte is set for the sector and then registered to the sync byte pattern table.

However, after a new sync byte has been set to the sector, the process may possibly end before updating the sync byte pattern table because of an unexpected operation, such as interruption of the power to the magnetic disk apparatus 1. When the sync byte of the sector does not coincide with the sync byte held in the table in the above case, data may be read out in the following method.

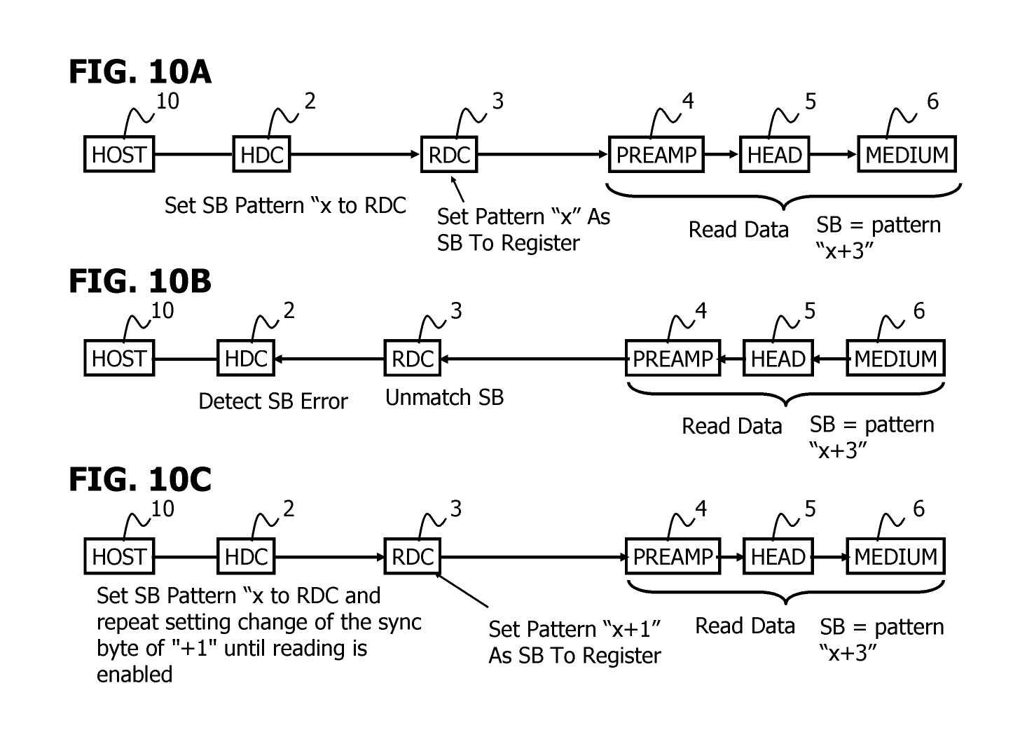

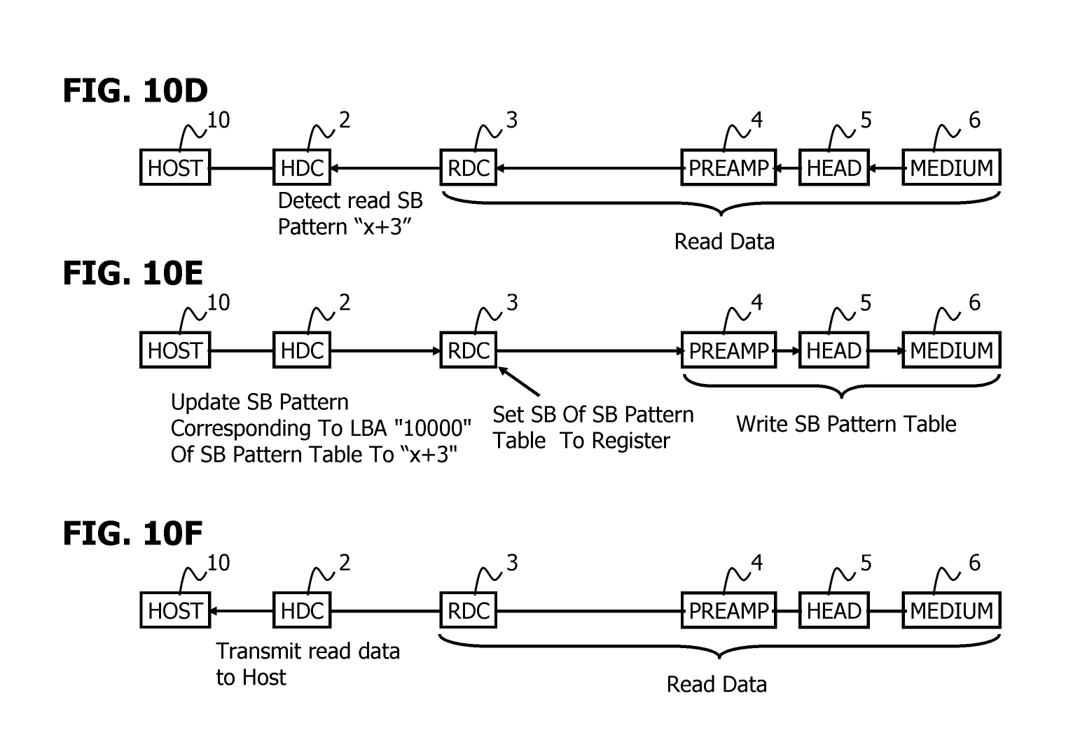

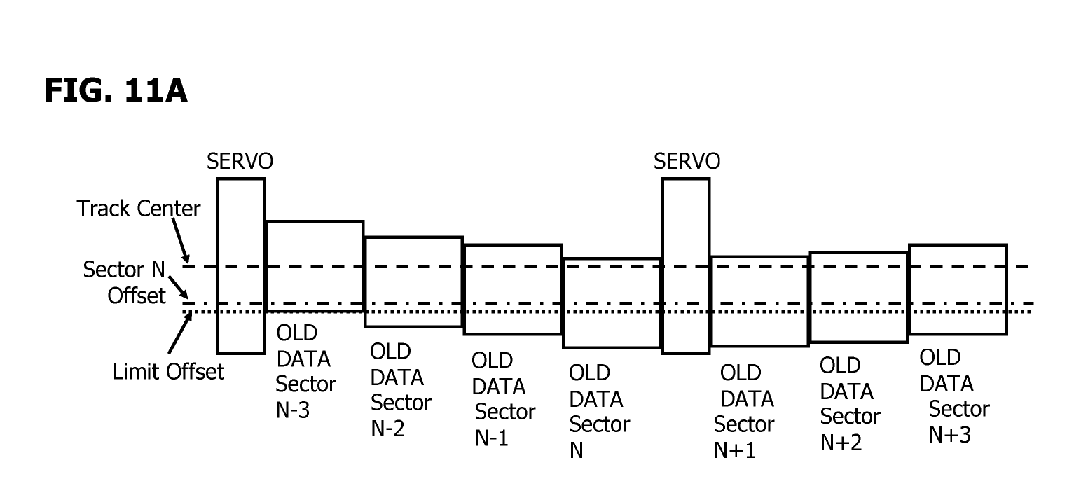

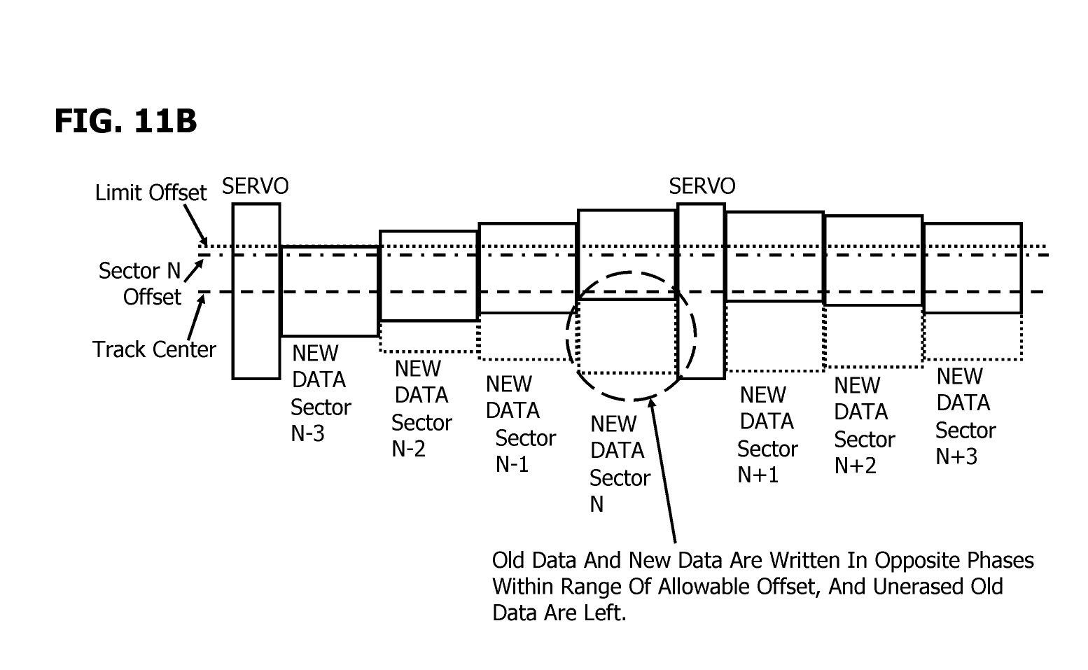

FIG. 10A, FIG. 10B, FIG. 10C, FIG. 10D, FIG. 10E, and FIG. 10F are views that illustrate a retry process for reading data when a data writing operation ends before updating the sync byte pattern table. The case in which the sync byte value set in the sector of LBA “10000” is “x+3”, whereas “x” is registered in the corresponding sync byte pattern table, will be described.

First, the step of FIG. 10A is similar to FIG. 6E in the steps of the reading process, and the sync byte “x” acquired from the sync byte pattern table is set in the register in the RDC 3, and then the sync byte is read out from the recording medium 6.

Next, in the step of FIG. 10B, because the sync byte of the sector is “x+3”, which is different from the value set in the RDC 3, so that the HDC 2 detects a sync byte error. In the step of FIG. 10C, as the HDC 2 detects the sync byte error, the HDC 2 refers to a table that is prepared beforehand in a firmware for retry operation. Then, the sync byte having a different value is set in the register of the RDC 3 (in the example of FIG. 10, “x+1” is set) and the step of FIG. 10B is retried.

Here, the set sync byte value is determined in accordance with a rule by which a new sync byte is set at the time of retry and the rule is stored in the retry table. In the example illustrated in FIG. 10, the value is reset in accordance with a rule that the sync byte value is incremented by one at the time of retry.

In the following process, the sync byte that coincides with the sync byte of the sector is set to the RDC 3, and the steps of FIG. 10B and FIG. 10C are repeated until reading is enabled. In step of FIG. 10D, by setting the sync byte “x+3” to the register of the RDC 3, reading of data in the sector is enabled.

In step of FIG. 10E, “x+3” is registered in the sync byte pattern table as the sync byte value for the sector of LBA “10000”. In step of FIG. 10F, the HDC 2 transmits the read data to the host 10, and the process ends.

Note that the example illustrated in FIG. 10 illustrates the retry process of reading data; even in the process of writing data, for example, when a sync byte error occurs in the step of FIG. 6B, by resetting the sync byte value with reference to the retry table, it is possible to perform retry operation.

As described above, according to the magnetic disk apparatus of the present embodiment, a sync byte different from the sync byte before writing is set every time data are written to the sector, and when data are read out, reading of data is performed using the latest updated sync byte. Even when unerased old data are present in the sector, because a sync byte different from that of new data is set, there is no chance to erroneously read the old data and it is possible to determine whether data are new or old.

Then, because it is possible to determine whether data are new or old, even when unerased old data due to offset writing are present, there is no chance to erroneously read the old data, and it is possible to reduce the occurrence of incorrect data reading at the time of reading data.

Note that the magnetic disk apparatus is described above; however, the aspects of the invention are not limited to it. As long as a disk apparatus is provided with a recording medium that is configured to record data in sectors, and the disk apparatus determines whether data are new or old using identification information, such as a sync byte, the disk apparatus is included in the aspects of the invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

What is claimed is:

1. An apparatus for storing data, comprising:
a medium for storing data including a plurality of sectors, each of the plurality of sectors including a synchronization mark indicating the position of the start of data in each of the sectors;
a memory for storing types of synchronization marks stored in the sectors;
a processor for executing a process comprising:
receiving a write request for writing data into one of the sectors;
reading out a type of the synchronization mark corresponding to the one of the sectors identified by the write request from the memory;
overwriting data and a new synchronization mark different from the synchronization mark read out from the memory into the sector;
overwriting the new synchronization mark to correspond to the one of the sector into the memory;
receiving a read request for reading out the data from one of the sectors;
reading out the synchronization mark and the data from one of the sectors identified by the read request;
reading out the type of the synchronization mark corresponding to the one of the sectors identified by the read request from the memory; and
determining whether correct data is read out from the sector by matching the type of the synchronization mark between read out from the sector and read out from the memory.

2. The apparatus according to claim 1, wherein the memory is a part of area of the medium.

3. The apparatus according to claim 1, wherein the memory is provided in a nonvolatile memory.

4. The apparatus according to claim 1, wherein the process further comprises obtaining respective pieces of synchronization mark for the plurality of successive sectors from the memory when writing to a plurality of successive sectors is performed in accordance with command, and wherein the overwriting overwrites the data to the plurality of successive sectors and the overwriting sequentially overwrites the synchronization mark into the memory.

5. The apparatus according to claim 1, wherein
the process further comprises obtaining respective pieces of synchronization mark for the plurality of successive sectors from the memory when data are read from the plurality of successive sectors in accordance with command for data reading, and wherein the reading out sequentially reads the synchronization mark for the plurality of successive sectors,

6. The apparatus according to claim 1, further comprising a storage module that stores information regarding setting of sector information by the overwriting process for retry process, wherein when writing of data ends before the new synchronization mark is registered in the memory, the overwriting process overwrites another synchronization mark, which is different from the new synchronization mark on the basis of information stored in the storage module to execute retry of writing of data.

7. A method for an apparatus for storing data including a medium for storing data including a plurality of sectors, each of the plurality of sectors including a synchronization mark indicating the position of the start of data in each of the sectors, and a memory for storing types of synchronization marks stored in the sectors, the method comprising:
receiving a write request for writing data into one of the sectors;
reading out a type of the synchronization mark corresponding to the one of the sectors identified by the write request from the memory;
overwriting data and a new synchronization mark different from the synchronization mark read out from the memory into the sector;
overwriting the new synchronization mark to correspond to the one of the sector into the memory;
receiving a read request for reading out the data from one of the sectors;
reading out the synchronization mark and the data from one of the sectors identified by the read request;
reading out the type of the synchronization mark corresponding to the one of the sectors identified by the read request from the memory; and
determining whether correct data is read out from the sector by matching the type of the synchronization mark between read out from the sector and read out from the memory.
